(19) United States
(12) Patent Application Publication
(10) Pub. No.: US 2025/0315988 A1
(43) Pub. Date: Oct. 9, 2025

(54) ARTIFICIAL INTELLIGENCE-BASED IMAGE GENERATION METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Zhouxia WANG, Shenzhen (CN); Xintao WANG, Shenzhen (CN); Liangbin XIE, Shenzhen (CN); Zhongang QI, Shenzhen (CN); Ying SHAN, Shenzhen (CN); Ping LUO, Shenzhen (CN)

(73) Assignee: TENCENT TECHNOLOGY (SHENZHEN) COMPANY LIMITED, Shenzhen (CN)

(21) Appl. No.: 19/242,249

(22) Filed: Jun. 18, 2025

Related U.S. Application Data
(63) Continuation of application No. PCT/CN2024/093200, filed on May 14, 2024.

(30) Foreign Application Priority Data
Jul. 5, 2023 (CN) 202310820471.6

(51) Int. Cl. G06T 11/00; G06F 40/109

(52) U.S. Cl. CPC G06T 11/00; G06F 40/109

(57) ABSTRACT

The present disclosure provides an artificial intelligence (AI)-based image generation method and apparatus, an electronic device, a computer-readable storage medium, and a computer program product. One method includes obtaining content text; obtaining at least one style image having a target style; performing text encoding processing on the content text to obtain content text code of the content text; extracting style code from the at least one style image; and performing reverse diffusion processing on a noise image based on a dual cross-attention mechanism corresponding to the style code and the content text code to obtain a target image, wherein the target image corresponds to the content text and has the target style.

### RELATED APPLICATION

This application is a continuation application of PCT Patent Application No. PCT/CN2024/093200, filed on May 14, 2024, which is based upon and claims priority to Chinese Patent Application No. 202310820471.6, filed on Jul. 5, 2023, both of which are incorporated herein by reference in their entireties.

### FIELD OF THE TECHNOLOGY

The present disclosure relates to an artificial intelligence (AI) technology, and in particular, to an artificial intelligence-based image generation method and apparatus, an electronic device, a computer-readable storage medium, and a computer program product.

### BACKGROUND OF THE DISCLOSURE

Artificial intelligence (AI) is a comprehensive technology in computer science that enables machines to have functions of perception, reasoning, and decision-making by studying design principles and implementation methods of various intelligent machines. An AI technology is a comprehensive subject, and relates to a wide range of fields, such as natural language processing (NLP) machine learning, and deep learning. With the development of technologies, the AI technology will be applied to more fields and play an increasingly important role.

A style transfer technology has been applied to various image editing scenarios and image generation scenarios. Image content related to a style transfer solution in related technologies usually relates to a specified content image. That is, style transfer is performed on an existing image. In addition, style transfer effects are relatively coarse-grained and are mainly color-based. Consequently, an image meeting a content requirement and a style requirement cannot be efficiently and accurately generated.

The present disclosure describes various embodiments for generating image based on artificial intelligence (AI), addressing at least one of the issues/problems discussed above, efficiently generating an image meeting a content requirement and a style requirement, thus improving the field of AI technology and the field of AI-based image generation technology.

### SUMMARY

Embodiments of the present disclosure provide an AI-based image generation method and apparatus, an electronic device, a computer-readable storage medium, and a computer program product, which can efficiently generate an image meeting a content requirement and a style requirement.

Technical solutions of the embodiments of the present disclosure are implemented as portions and/or combinations of all implementations/embodiments described in the present disclosure.

The present disclosure describes a method for generating image based on artificial intelligence (AI), performed by an electronic device comprising a memory storing instructions and a processor in communication with the memory. The method includes obtaining content text; obtaining at least one style image having a target style; performing text encoding processing on the content text to obtain content text code of the content text; extracting style code from the at least one style image; and performing reverse diffusion processing on a noise image based on a dual cross-attention mechanism corresponding to the style code and the content text code to obtain a target image, wherein the target image corresponds to the content text and has the target style.

The present disclosure describes an apparatus for generating image based on artificial intelligence (AI). The apparatus includes a memory storing instructions; and a processor in communication with the memory. When the processor executes the instructions, the processor is configured to cause the apparatus to perform: obtaining content text; obtaining at least one style image having a target style; performing text encoding processing on the content text to obtain content text code of the content text; extracting style code from the at least one style image; and performing reverse diffusion processing on a noise image based on a dual cross-attention mechanism corresponding to the style code and the content text code to obtain a target image, wherein the target image corresponds to the content text and has the target style.

The present disclosure describes a non-transitory computer-readable storage medium, storing computer-readable instructions. The computer-readable instructions, when executed by a processor, are configured to cause the processor to perform: obtaining content text; obtaining at least one style image having a target style; performing text encoding processing on the content text to obtain content text code of the content text; extracting style code from the at least one style image; and performing reverse diffusion processing on a noise image based on a dual cross-attention mechanism corresponding to the style code and the content text code to obtain a target image, wherein the target image corresponds to the content text and has the target style.

The embodiments of the present disclosure provide an AI-based image generation method, including:
obtaining content text, and obtaining a style image having a target style;
performing text encoding processing on the content text to obtain content text code of the content text, and extracting style code from the style image; and
performing reverse diffusion processing on a noise image based on a dual cross-attention mechanism corresponding to the style code and the content text code to obtain a target image,
the target image matching content of the content text, and the target image having the target style.

The embodiments of the present disclosure provide an AI-based image generation apparatus, including:
an obtaining module, configured to obtain content text, and obtain a style image having a target style;
an encoding module, configured to perform text encoding processing on the content text to obtain content text code of the content text, and extract style code from the style image; and
a reverse diffusion module, configured to perform reverse diffusion processing on a noise image based on a dual cross-attention mechanism corresponding to the style code and the content text code to obtain a target image, the target image matching content of the content text, and the target image having the target style.

The embodiments of the present disclosure provide an electronic device, including:
a memory, configured to store computer-executable instructions; and
a processor, configured to implement, when executing the computer-executable instructions stored in the memory, the AI-based image generation method according to the embodiments of the present disclosure.

The embodiments of the present disclosure provide a computer-readable storage medium, having computer-executable instructions stored therein, configured to implement, when executed by a processor, the AI-based image generation method according to the embodiments of the present disclosure.

The embodiments of the present disclosure provide a computer program product, including a computer program or computer-executable instructions, the computer program or the computer-executable instructions, when executed by a processor, implementing the AI-based image generation method according to the embodiments of the present disclosure.

The embodiments of the present disclosure have the following beneficial effects:
content text is obtained, a style image having a target style is obtained, text encoding processing is performed on the content text to obtain content text code of the content text, and style encoding processing is performed on the style image to obtain style code. The content text code and the style code are fused into a process of performing reverse diffusion processing on a noise image by using a dual cross-attention mechanism, so that a target image matching the content text and the target style can be obtained at a time, thereby improving image generation efficiency.

### BRIEF DESCRIPTION OF THE DRAWINGS

FIG. 1 is a schematic structural diagram of an AI-based image generation system according to an embodiment of the present disclosure.

FIG. 2 is a schematic structural diagram of an electronic device according to an embodiment of the present disclosure.

FIG. 3A to FIG. 3D are schematic flowcharts of an AI-based image generation method according to an embodiment of the present disclosure.

FIG. 4 is a schematic diagram of a model of an AI-based image generation method according to an embodiment of the present disclosure.

FIG. 5 is a schematic diagram of a model of an AI-based image generation method according to an embodiment of the present disclosure.

FIG. 6A to FIG. 6C are effect schematic diagrams of an AI-based image generation method according to an embodiment of the present disclosure.

FIG. 7 is an effect schematic diagram of an AI-based image generation method according to an embodiment of the present disclosure.

### DESCRIPTION OF EMBODIMENTS

To make objectives, technical solutions, and advantages of the present disclosure clearer, the following describes the present disclosure in further detail with reference to accompanying drawings. Described embodiments are not to be considered as a limitation to the present disclosure. All other embodiments obtained by a person of ordinary skill in the art without creative efforts fall within the protection scope of the present disclosure.

In the following descriptions, “some embodiments” is related, which describes a subset of all possible embodiments. However, the “some embodiments” may be the same subset or different subsets of all the possible embodiments, and may be combined with each other without conflict.

In the following descriptions, involved terms “first/second/third” are merely intended to distinguish similar objects rather than describing specific order of the objects. “First/second/third” is interchangeable in specific order or sequence where permitted, so that the embodiments of the present disclosure described herein can be implemented in another order other than the order illustrated or described herein.

Unless otherwise defined, meanings of all technical and scientific terms used in this specification are the same as those usually understood by a person skilled in the art to which the present disclosure belongs. Terms used herein are merely intended to describe the embodiments of the present disclosure, but are not intended to limit the present disclosure.

The embodiments of the present disclosure relate to technologies of AI, NLP, and computer vision (CV).

The AI technology is a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, a pre-trained model technology, an operating/interaction system, and electromechanical integration. The pre-trained model is alternatively referred to as a large model or a basic model, and may be widely applied to downstream tasks in various major directions of AI after fine tuning. AI software technologies mainly include several major directions such as a CV technology, a speech processing technology, a natural language processing technology, and machine learning/deep learning.

The CV technology is a science that studies how to use a machine to “see”, and furthermore, that uses a camera and a computer to replace human eyes to perform machine vision such as recognition and measurement on a target, and further perform graphic processing, so that the computer processes the target into an image that is more suitable for human eyes to observe or to be transmitted to an instrument for detection. As a scientific discipline, CV studies related theories and technologies and attempts to establish an AI system that can obtain information from images or multidimensional data. Large model technologies bring an important change to development of the CV technology, a pre-trained model in a field of vision may be quickly and widely applicable to specific downstream tasks after fine tuning. The CV technology generally includes technologies such as image processing, image recognition, image semantic understanding, image retrieval, optical character recognition (OCR), video processing, video semantic understanding, video content/behavior recognition, three-dimensional object reconstruction, 3D technology, virtual reality, augmented reality, and simultaneous localization and mapping, and further includes common biometric recognition technologies such as face recognition and fingerprint recognition.

The NLP is an important direction in the field of computer science and AI. The NLP studies various theories and methods that can realize efficient communication between humans and computers by using a natural language. The NLP involves the natural language, that is, a language that people use in daily lives, so that the NLP is closely related to the study of linguistics. Meanwhile, computer science and mathematics are involved. An important technology of model training in the field of AI, that is, a pre-trained model, is developed from a large language model in the field of NLP. After fine tuning, the large language model may be widely applied to downstream tasks. The NLP technology usually includes technologies such as text processing, semantic understanding, machine translation, robot questions and answers, and knowledge graph.

Before the embodiments of the present disclosure are further described in detail, a description is made on nouns and terms in the embodiments of the present disclosure, and the nouns and terms in the embodiments of the present disclosure are applicable to the following explanations.

(1) U-Net: A common convolution-based deep learning network architecture has a U-shaped feature connection manner, and U-Net is usually configured for performing an image segmentation task.

(2) Stable diffusion (SD) model: A working principle of the diffusion model is to learn information attenuation caused by noise, and then to generate an image by using a learned mode.

(3) Embedding: A high-dimensional vector may be transformed into a relatively low-dimensional space by using an Embedding technology, so that machine learning is easier and more efficient. This technology is mainly applied to the fields of NLP and machine learning. This technology refers to transforming a high-dimensional sparse vector into a low-dimensional dense real number vector. This process is alternatively referred to as word embedding or vector embedding, and semantic information may be encoded into the low-dimensional vector. Such transformation is usually completed through deep learning network training.

In some implementations, a related technology may include a conventional style transfer method and a diffusion model-based style generation method. An input of the conventional style transfer method includes a content image and a style image. After features of the content image and the style image are separately extracted, transfer from a style of the style image to the content image is implemented by using an additional style mapper. In the diffusion model-based style generation method, a diffusion model is repeatedly and finely tuned by learning placeholders of one or more style images in text space, or inputting these style images into the diffusion model, so that the diffusion model corresponding to a style is trained, thereby invoking the diffusion model corresponding to the style to generate an image having the style by using a prompt as an input.

In the conventional style transfer method, content comes from a specified content image. Style transfer effects of the conventional style transfer method are relatively coarse-grained and are mainly color-based, and style transfer is performed on an existing image. However, in the diffusion model-based style generation method, a model needs to be trained for each style, resulting in relatively high training costs. Therefore, solutions in the related technology cannot have both good effects and high efficiency.

Based on the above technical problems, the embodiments of the present disclosure provide an image generation method and apparatus, an electronic device, a computer-readable storage medium, and a computer program product, which can efficiently generate an image having specified semantics and a reference style.

The image generation method according to the embodiments of the present disclosure may be independently implemented by a terminal/a server. The image generation method may be implemented through cooperation of the terminal and the server. For example, the terminal independently performs the following image generation method, or, the terminal sends an image generation request (carrying content text and a style image) to the server, and the server performs the image generation method according to the received image generation request, performs text encoding processing on the content text to obtain content text code of the content text, and performs style encoding processing on the style image to obtain style code. Based on a dual cross-attention mechanism corresponding to the style code and the content text code, reverse diffusion processing is performed on a noise image to obtain a target image matching content of the content text and having a target style, and the server returns the target image to the terminal.

In some implementations, a noise image may refer to one of the following: a raw image, a machine-generated image, or an image that is stored in an image database or image repository. In some implementations, a noise image may include one or more types of image noise or may be processed by adding one or more types of image noise. The image noise may include at least one of the following: white noise, Gaussian noise, shot noise, Poisson noise, multiplicative noise, salt and pepper noise, impulsive noise, etc.

The electronic device configured to perform an image generation method according to the embodiments of the present disclosure may include various types of terminal devices or servers, where the server may be an independent physical server, or may be a server cluster or a distributed system including a plurality of physical servers, or may be a cloud server that provides cloud computing services. The terminal may be a smartphone, a tablet computer, a notebook computer, a desktop computer, a smart speaker, a smart watch, and the like, but is not limited thereto. The terminal and the server may be directly or indirectly connected in a wired or wireless communication mode. This is not limited in the present disclosure.

Using the server as an example, for example, the server may be a server cluster deployed in a cloud, and opens AI as a service (AIaaS) to users. An AIaaS platform splits several common types of AI services, and provides an independent service or packaged service in the cloud. This service mode is similar to that of an AI theme mall. All users may access and use, by using an application programming interface, one or more AI services provided by using the AIaaS platform.

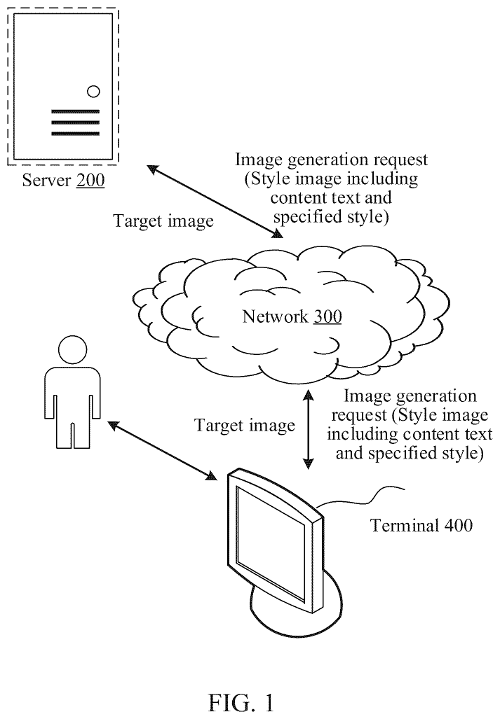

Refer to FIG. 1, which is a schematic diagram of architecture of an image generation system according to an embodiment of the present disclosure. A terminal 400 is connected to a server 200 through a network 300. The network 300 may be a wide area network, a local area network, or a combination thereof.

The terminal 400 (on which a clipping client runs) may be configured to obtain an image generation request. For example, a user inputs content text and a style image by using an input interface of the terminal 400 (controls corresponding to different styles are triggered through a selection operation, and after a control of any style is triggered, a plurality of style images corresponding to the styles are obtained) to generate the image generation request. The terminal 400 sends the image generation request to the server 200. The server 200 performs text encoding processing on the content text to obtain content text code of the content text, and performs style encoding processing on the style image to obtain style code. Based on a dual cross-attention mechanism corresponding to the style code and the content text code, reverse diffusion processing is performed on a noise image to obtain a target image matching content of the content text and having a target style. The server 200 returns the target image to the terminal 400.

In some embodiments, the client running in the terminal may be implanted with an image generation plug-in for locally implementing the image generation method in the client. For example, after obtaining the image generation request, the terminal 400 invokes the image generation plug-in to implement the image generation method, performs text encoding processing on the content text to obtain the content text code of the content text and performs style encoding processing on the style image to obtain the style code. Based on the dual cross-attention mechanism corresponding to the style code and the content text code, reverse diffusion processing is performed on the noise image to obtain the target image matching content of the content text and having the target style.

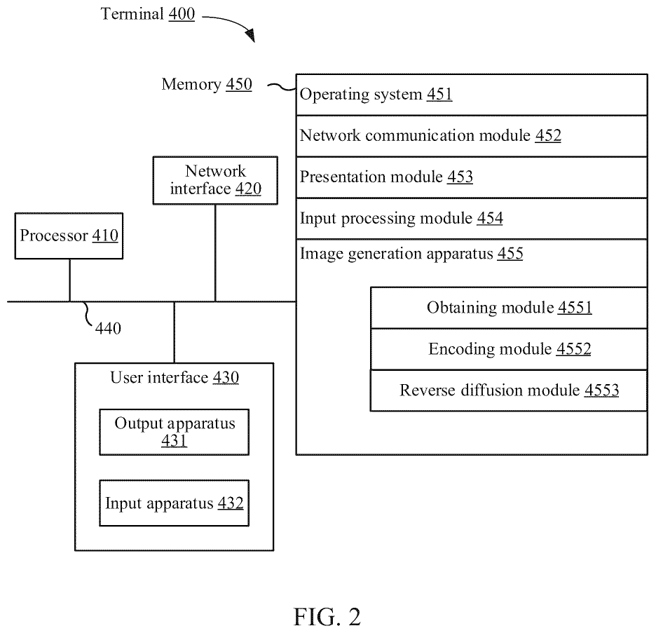

Refer to FIG. 2, which is a schematic structural diagram of an electronic device according to the embodiments of the present disclosure. The terminal 400 shown in FIG. 2 includes: at least one processor 410, a memory 450, at least one network interface 420, and a user interface 430. Various components in the terminal 400 are coupled together through a bus system 440. The bus system 440 is configured to implement connection and communication between the components. In addition to a data bus, the bus system 440 further includes a power bus, a control bus, and a state signal bus. However, for clarity of description, various buses are marked as the bus system 440 in FIG. 2.

The processor 410 may be an integrated circuit chip having a signal processing capability, for example, a general processor, a digital signal processor (DSP), or other programmable logic devices, discrete gates or transistor logic devices, or discrete hardware components. The general processor may be a microprocessor, any conventional processor, or the like.

The user interface 430 includes one or more output apparatuses 431 that can present media content, which includes one or more speakers and/or one or more visual display screens. The user interface 430 further includes one or more input apparatuses 432, which includes a user interface component that facilitates user input, for example, a keyboard, a mouse, a microphone, a touch display screen, a camera, and other input buttons and controls.

The memory 450 may be removable, irremovable or a combination thereof. An exemplary hardware device includes a solid memory, a hard disk drive, an optical disk drive, and the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in the embodiment of the present disclosure aims to include any other suitable type of memory.

In some embodiments, the memory 450 can store data to support various operations. Examples of the data include a program, a module, a data structure, or a subset or a superset thereof, which are exemplarily described below.

An operating system 451 includes system programs for processing various basic system services and performing hardware related tasks, such as a frame layer, a core library layer, and a drive layer, and is configured to implement various basic services and process hardware-based tasks.

A network communication module 452 is configured to reach other electronic devices via one or more (wired or wireless) network interfaces 420. An exemplary network interface 420 includes: Bluetooth, wireless fidelity (WiFi), universal serial bus (USB), or the like.

A presentation module 453 is configured to present information through one or more output apparatuses 431 (for example, a display screen and a loudspeaker) associated with the user interface 430 (for example, a user interface configured to operate a peripheral device and display content and information).

An input processing module 454 is configured to detect one or more user inputs or interactions from one or more input apparatuses 432 and translate the detected input or interaction.

In some embodiments, the image generation apparatus according to the embodiments of the present disclosure may be implemented in a software mode. FIG. 2 shows an image generation apparatus 455 stored in the memory 450. The apparatus 455 may be software in the form of a program and a plug-in, and the like, and includes the following software modules: an obtaining module 4551, an encoding module 4552, and a reverse diffusion module 4553. These modules are logical, and can be combined or further split according to functions implemented. The functions of the modules will be explained below.

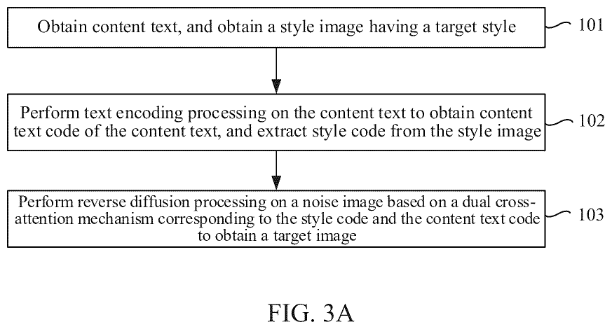

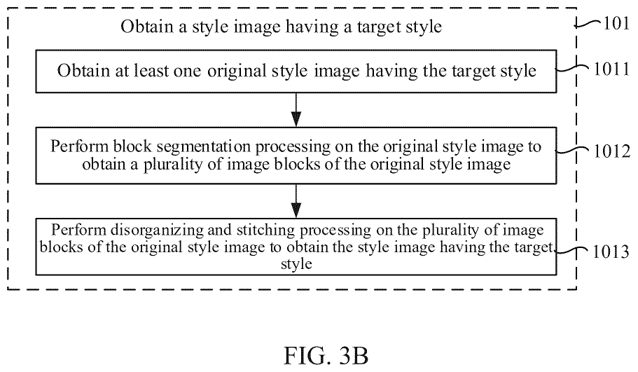

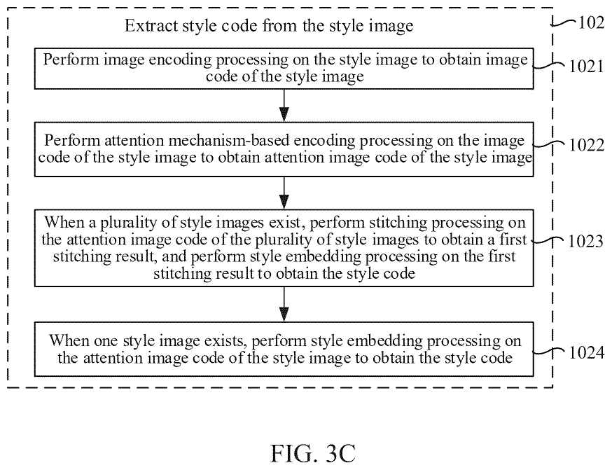

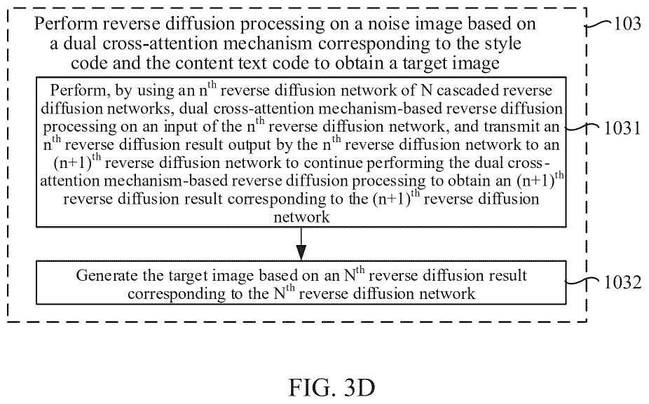

As previously, the image generation method according to the embodiments of the present disclosure may be implemented by various types of electronic devices. Descriptions are provided by using an example in which the image generation method is performed by a terminal. Refer to FIG. 3A, which is a schematic flowchart of an image generation method according to an embodiment of the present disclosure. Descriptions are provided with reference to operation 101 to operation 103 shown in FIG. 3A.

Operation 101: Obtain content text, and obtain a style image having a target style.

As an example, the content text herein is configured for controlling content of image generation. For example, if the content text is “motorcycle”, the content text may be configured for guiding generation of a target image including a motorcycle, that is, the target image matches content of the content text. For example, the target image includes an object mentioned in the content text.

In various embodiments in the present disclosure, “a style image” in the above operation 101 and various other operations/steps may be replaced by “at least one style image” or “one or more style images. The “at least one style image” or “one or more style images” may have only a single style image, or may have two or more style images having the same target style.

As an example, one or more style images may exist herein. If a plurality of style images exist, the style images all have the same style, and the style may be a comic style, a Van Gogh style, an oil-painting style, or the like. The same style means that the plurality of style images all belong to the same style, for example, all belong to the comic style, thereby guiding generation of the target image having the target style.

In some embodiments, refer to FIG. 3B. Operation 101 of obtaining the style image having the target style may be implemented through operation 1011 to operation 1013 shown in FIG. 3B.

Operation 1011: Obtain at least one original style image having the target style.

Operation 1012 to operation 1013 are performed for each original style image.

Operation 1012: Perform block segmentation processing on the original style image to obtain a plurality of image blocks of the original style image.

Operation 1013: Perform disorganizing and stitching processing on the plurality of image blocks of the original style image to obtain the style image having the target style.

According to this embodiment of the present disclosure, the original style image is disorganized based on the image blocks, and semantic information of the original style image is interfered while reserving style details such as texture and brush strokes in the original style image.

Operation 102: Perform text encoding processing on the content text to obtain content text code of the content text, and extract style code from the style image.

As an example, the text encoding processing may be performed on the content text herein by using a text model in a contrastive language-image pre-training (CLIP) model (or contrastive language-image pre-training (CLIP) process). Training data of the CLIP is a text-image pair (an image and a text description corresponding to the image). It is hoped that the CLIP model can learn a matching relationship of the text-image pair through contrastive learning herein. The CLIP model includes two models (or two parts): a text model (or a text part) and a vision model (or a vision part). The text model/part is configured for extracting a feature of text, and a Transformer model commonly used in NLP may be used. The vision model/part is configured for extracting a feature of an image, and a common convolutional neural network model or a visual Transformer model may be used.

In some embodiments, referring to FIG. 3C, operation 102 of extracting the style code from the style image may be implemented by performing operation 1021 to operation 1024 shown in FIG. 3C for each style image.

Operation 1021: Perform image encoding processing on the style image to obtain image code of the style image.

In some embodiments, operation 1021 of performing the image encoding processing on the style image to obtain the image code of the style image may be implemented by using the following technical solution: performing the following processing on each style image: obtaining semantic code representing a semantic type of the style image; obtaining a plurality of image blocks of the style image; performing second embedding processing on each image block to obtain visual code of each image block, and performing third embedding processing on each image block to obtain position code of each image block; performing stitching processing on the semantic code and the visual code of the plurality of image blocks to obtain a second stitching result; and performing superimposition processing corresponding to the image block on the second stitching result and the position code of each image block to obtain the image code. According to this embodiment of the present disclosure, semantic, positional, and visual encoding are performed on the style image, so that the obtained image code can have a good guiding effect.

As an example, the second embedding processing and the third embedding processing are actually mapping processing for the image block, but mapping parameters used are different. Mapping processing is performed on the style image by using a vision model. The vision model herein is from the CLIP. The vision model is obtained by pre-training. After the style image is mapped by using the vision model, semantic code representing a semantic type of the style image and visual code of each image block are output. Refer to Formula (1):

$${E}_{Ir} = [ {E}_{c l s} , {I}_{r}^{0} E , {I}_{r}^{1} E , {I}_{r}^{N - 1} E ] + {E}_{p o s} ; \qquad ( 1 )$$

where E_{Ir} is image code, E_{cls} is the semantic code representing the semantic type of the style image, Eₚₒₛ is position code of each image block, {Iᵣ⁰, Iᵣ¹, . . . Iᵣ^{N-1}} is non-overlapping image blocks obtained by dividing the style image, and E represents a mapping parameter used in the second embedding processing. Herein, Eₚₒₛ represents the position code of each image block in the style image, semantic code does not participate in superimposition processing, and the position code of the image block in the style image is superimposed onto the visual code of the image block.

In some embodiments, before the performing attention mechanism-based encoding processing on the image code of the style image to obtain attention image code of the style image, the following processing is performed on each style image: removing the semantic code representing the semantic type of the style image from the image code of the style image, and updating a removal result to the image code of the style image.

In an example, semantic information of the semantic code E_{cls} is closely associated with semantic information of the style image, so the semantic information in the style image is discarded by removing the semantic code E_{cls} in this embodiment of the present disclosure. According to the embodiments of the present disclosure, a representing capability of style characteristics can be improved, and an impact of the semantic information on image generation can be reduced.

According to this embodiment of the present disclosure, type embedding suppression can be implemented, because an objective is to suppress the semantic information in the style image to avoid damaging content fidelity of an output image, semantic-related information is eliminated when the feature of the style image is extracted by using the vision model.

Operation 1022: Perform attention mechanism-based encoding processing on the image code of the style image to obtain attention image code of the style image.

As an example, herein, attention mechanism-based encoding processing is implemented by using a transformer network structure. The transformer network structure is formed by cascading a plurality of self-attention modules, and data processing of the self-attention modules is implemented by using an Attention formula of a self-attention mechanism.

Operation 1023: When a plurality of style images exist, perform stitching processing on the attention image code of the plurality of style images to obtain a first stitching result, and perform first embedding processing on the first stitching result to obtain the style code.

Operation 1024: When one style image exists, perform the first embedding processing on the attention image code of the style image to obtain the style code.

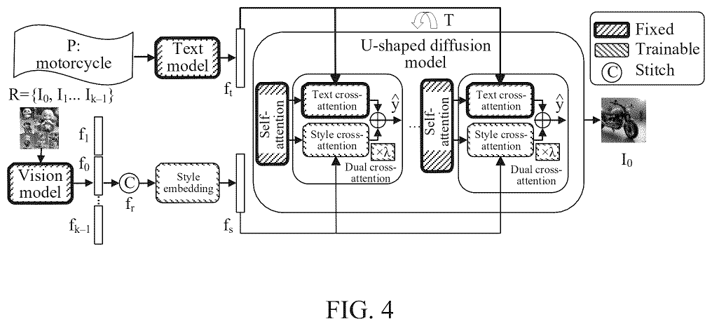

As an example, referring to FIG. 4, when a plurality of style images exist, the stitching processing is performed on the attention image code of the plurality of style images to obtain a first stitching result fᵣ, then the first embedding processing is performed on the first stitching result fᵣ to obtain the style code. When one style image exists, the first embedding processing may be directly performed on the attention image code of the style image to obtain the style code.

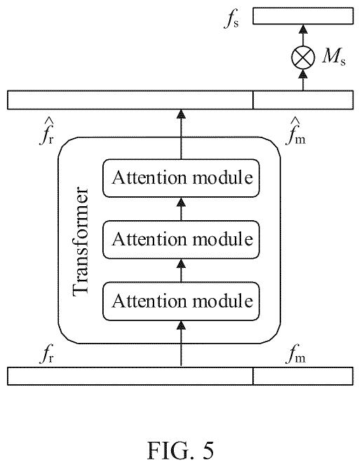

As an example, the following describes a process of the first embedding processing. A style embedding network (Style Emb) involved in this embodiment of the present disclosure is described with reference to FIG. 5. The style embedding network is a Transformer structure including a plurality of attention modules. An input of the style embedding network is formed by stitching the first stitching result fᵣ and a learnable embedded feature fₘ. After using the Transformer structure, \hat{f}ᵣ and \hat{f}ₘ are generated, and \hat{f}ₘ is mapped to fₛ (the style code) through a learnable matrix Mₛ to participate in a subsequent generation process.

According to this embodiment of the present disclosure, attention image code of the plurality of style images may be fused, so that style information of the plurality of style images may be obtained, thereby improving accuracy of the style code.

In some embodiments, the text encoding processing and the image encoding processing are implemented by invoking a CLIP model. The CLIP model includes a vision model and a text model, and is configured to: obtain a plurality of first text samples and a first image sample matching each first text sample; perform, by using the vision model of the CLIP model, image encoding processing on each first image sample to obtain image code of each first image sample; perform, by using the text model of the CLIP model, text encoding processing on each first text sample to obtain text code of each first text sample; determine a text-image contrastive loss based on the text code of each first text sample, the image code of each first image sample, and a matching relationship between each first text sample and each first image sample; and update a parameter of the CLIP model based on the text-image contrastive loss.

As an example, the CLIP model first inputs the first image sample and the first text sample that match each other into a vision model image_encoder and a text model text_encoder respectively to obtain vector representations I-f and T_f of the first image sample and the first text sample. Then, the vector representations of the first image sample and the first text sample are mapped to multimodal space to obtain vector representations I_e and T_e of the first image sample and the first text sample that may be directly compared. This is a method in multi-modal learning. There may be a gap between data representations in different modalities, so that the data representations cannot be directly compared. Therefore, mapping data in different modalities to the same multi-modal space first facilitates subsequent operations such as similarity calculation. A cosine similarity between the vector representation of the first image sample and the vector representation of the first text sample is calculated. An objective function for contrastive learning is to enable a positive sample pair (the first image sample and the first text sample that match each other) to have a high similarity, and a negative sample pair (the first image sample and the first text sample that do not match each other) to have a low similarity.

Operation 103: Perform reverse diffusion processing on a noise image based on a dual cross-attention mechanism corresponding to the style code and the content text code to obtain a target image.

As an example, the target image matches content of the content text, and the target image has the target style.

In some embodiments, referring to FIG. 3D, operation 103 of performing the reverse diffusion processing on the noise image based on the dual cross-attention mechanism corresponding to the style code and the content text code to obtain the target image may be implemented by using operation 1031 and operation 1032 shown in FIG. 3D.

Operation 1031: Perform, by using an n^{th} reverse diffusion network of N cascaded reverse diffusion networks, dual cross-attention mechanism-based reverse diffusion processing on an input of the n^{th} reverse diffusion network, and transmitting an n^{th} reverse diffusion result output by the n^{th} reverse diffusion network to an (n+1)^{th} reverse diffusion network to continue performing the dual cross-attention mechanism-based reverse diffusion processing to obtain an (n+1)^{th} reverse diffusion result corresponding to the (n+1)^{th} reverse diffusion network.

Operation 1032: Generate the target image based on an N^{th} reverse diffusion result corresponding to the N^{th} reverse diffusion network.

As an example, n is an integer variable whose value progressively increases from 1. A value range of n is 1≤n<N. When a value of n is 1, an input of the n^{th} reverse diffusion network is the noise image, the content text code, and the style code; and when the value of n is 2≤n<N, the input of the n^{th} reverse diffusion network is an (n−1)^{th} reverse diffusion result output by an (n−1)^{th} reverse diffusion network, the content text code, and the style code.

As an example, n reverse diffusion networks are cascaded, which is equivalent to that T times of reverse diffusion processing are performed. In each time of reverse diffusion processing, reverse diffusion processing and random sampling processing are performed according to a noise image obtained through previous reverse diffusion (that is, a reverse diffusion result obtained through the previous reverse diffusion), and then input the reverse diffusion result into a next reverse diffusion network for reverse diffusion processing and random sampling processing, where n is an integer variable whose value progressively increases from 1. A value range n is 1≤n<N. When a value of n is 1, an input of the n^{th} reverse diffusion network is the noise image (or hidden noise image code), content text code, and style code. When the value of n is 2≤n<N, the input of the n^{th} reverse diffusion network is an (n−1)th reverse diffusion result outputted by an (n−1)^{th} reverse diffusion network, the content text code, and the style code.

As an example, an example in which N is 3 is used for description. Reverse diffusion processing is performed on the noise image (or the hidden space noise code), the content text code, and the style code by using a first reverse diffusion network to obtain a first reverse diffusion result; reverse diffusion processing is performed on the first reverse diffusion result and the content text code by using a second reverse diffusion network to obtain a second reverse diffusion result; reverse diffusion processing is performed on the second reverse diffusion result, the content text code, and the style code by using a third reverse diffusion network to obtain a third reverse diffusion result. Each reverse diffusion result obtained in the foregoing mode is an image (or hidden space code). Reverse diffusion processing performed by each reverse diffusion network is equivalent to reverse diffusion processing of one time step.

As an example, when the N^{th} reverse diffusion result is the hidden space code, random distribution is generated based on the N^{th} reverse diffusion result, sampling is performed from the random distribution to obtain hidden space image code, and encoding processing is performed on the hidden space image code to obtain the target image. After performing reverse diffusion processing each time by using a reverse diffusion network, obtained data is used as an average value of random distribution, and a variance is set data, so as to obtain random distribution corresponding to a reverse diffusion result. Then, sampling is performed on the random distribution to obtain the reverse diffusion result, and the reverse diffusion result is input to a next reverse diffusion network. When the N^{th} reverse diffusion result is an image, the N^{th} reverse diffusion result is directly used as the target image.

According to this embodiment of the present disclosure, denoising processing may be gradually performed on the hidden space noise code or the noise image to obtain a denoising result of hidden space or a denoising result of real space. A denoising process is implemented in the hidden space, a data processing amount is reduced and a denoising speed is improved. By denoising in the real space, visual evaluation may be performed in a denoising process, a denoising effect may be optimized, and calculation resources may be saved.

In some embodiments, the n^{th} reverse diffusion network includes cascaded M sampling networks, and a value of M satisfies: 2≤M. Operation 1031 of performing dual cross-attention mechanism-based reverse diffusion processing on the input of the n^{th} reverse diffusion network by using the n^{th} reverse diffusion network of the N cascaded reverse diffusion networks may be implemented by using the following technical solution: performing, by using an m^{th} sampling network in the m cascaded sampling networks, dual cross-attention mechanism-based sampling processing on an input of the m^{th} sampling network to obtain an m^{th} sampling result corresponding to the m^{th} sampling network, and transmitting the m^{th} sampling result corresponding to the m^{th} sampling network to an (m+1)^{th} sampling network to continue performing the dual cross-attention mechanism-based sampling processing to obtain an (m+1)^{th} sampling result corresponding to the (m+1)^{th} sampling network; and using a sampling result outputted by an M^{th} sampling network as the n^{th} reverse diffusion result. According to this embodiment of the present disclosure, a dual cross-attention mechanism is combined with sampling processing. Single sampling is actually a process of extracting a feature by using convolution. Dual cross-attention mechanism-based sampling is a process of extracting a feature by using two attention mechanisms, so that targeted sampling can be implemented and a representation capability of a model can be improved.

As an example, m is an integer variable whose value progressively increases from 1. A value range of m is 1≤m≤M−1. When a value of m is 1, an input of the m^{th} sampling network is an input of the n^{th} reverse diffusion network, the content text code, and the style code; and when a value of m is 2≤m<M, the input of the m^{th} sampling network is an (m−1)^{th} sampling result output by an (m−1)^{th} sampling network, the content text code, and the style code.

As an example, a second reverse diffusion network is used as an example for description. The reverse diffusion network may include three downsampling networks and three upsampling networks. Downsampling processing is performed on the first reverse diffusion result, the content text code, and the style code by using three cascaded downsampling networks to obtain a downsampling result of the second reverse diffusion network. Upsampling processing is performed on a downsampling result of the second reverse diffusion network, the content text code, the style code by using three cascaded upsampling networks to obtain an upsampling result of the second reverse diffusion network as a noise estimation result of the second reverse diffusion network. Noise cancellation processing is performed on the first reverse diffusion result based on the noise estimation result of the second reverse diffusion network to obtain a second reverse diffusion result corresponding to the second reverse diffusion network.

As an example, downsampling processing is performed on an input of a first downsampling network by using the first downsampling network to obtain a downsampling result corresponding to the first downsampling network, and the downsampling result corresponding to the first downsampling network is transmitted to a second downsampling network to continue performing downsampling processing to obtain a second downsampling result corresponding to the second downsampling network. Downsampling processing is performed on an input of the second downsampling network by using the second downsampling network to obtain a downsampling result corresponding to the second downsampling network. The downsampling result corresponding to the second downsampling network is transmitted to a third downsampling network to continue performing downsampling processing to obtain a third downsampling result corresponding to the third downsampling network, and the third downsampling result output by the third downsampling network is used as the second reverse diffusion result. Herein, in addition to an output of a previous network, an input of each downsampling network further includes the content text code and the style code.

In some embodiments, the transmitting the m^{th} sampling result corresponding to the m^{th} sampling network to an (m+1)^{th} sampling network to continue performing the dual cross-attention mechanism-based sampling processing to obtain an (m+1)^{th} sampling result corresponding to the (m+1)^{th} sampling network may be implemented by using the following technical solution: performing self-attention processing on the m^{th} sampling result corresponding to the m^{th} sampling network to obtain a self-attention processing result of the (m+1)^{th} sampling network; performing cross-attention processing on the self-attention processing result of the (m+1)^{th} sampling network and the content text code to obtain a text cross-attention processing result of the (m+1)^{th} sampling network; performing cross-attention processing on the self-attention processing result of the (m+1)^{th} sampling network and the style code to obtain a style cross-attention processing result of the (m+1)^{th} sampling network; and performing fusion processing on the style cross-attention processing result of the (m+1)^{th} sampling network and the text cross-attention processing result of the (m+1)^{th} sampling network to obtain an (m+1)^{th} sampling result corresponding to the (m+1)^{th} sampling network. According to this embodiment of the present disclosure, style guidance and content guidance may be combined, to ensure a generation effect of the target image in two aspects.

As an example, the self-attention processing is implemented by using an Attention formula of a self-attention mechanism. Subsequently, cross-attention processing is separately performed on a self-attention processing result and the content text code as well as the style code to obtain two cross-attention processing results, and then the two cross-attention processing results are fused by using a parameter λ to obtain an (m+1)^{th} sampling result of the (m+1)^{th} sampling network, referring to Formula (2):

$$\hat{y} = Attention ( {Q}_{t} , {K}_{t} , {V}_{t} ) + λ Attention ( {Q}_{s} , {K}_{s} , {V}_{s} ) ; \qquad ( 2 )$$

where ŷ is the (m+1)^{th} sampling result of the (m+1)^{th} sampling network, λ is a trainable fusion parameter, Attention (Qₛ, Kₛ, Vₛ) is a style cross-attention processing result, and Attention (Qₜ, Kₜ, Vₜ) is a text cross-attention processing result.

In some embodiments, the performing cross-attention processing on the self-attention processing result of the (m+1)^{th} sampling network and the content text code to obtain a text cross-attention processing result of the (m+1)^{th} sampling network may be implemented by using the following technical solution: performing first query parameter-based mapping processing on the self-attention processing result of the (m+1)^{th} sampling network to obtain a first query matrix; performing first key parameter-based mapping processing on the content text code to obtain a first key matrix; performing first value parameter-based mapping processing on the content text code to obtain a first value matrix; and performing attention calculation on the first query matrix, the first key matrix, and the first value matrix to obtain the text cross-attention processing result of the (m+1)^{th} sampling network. According to this embodiment of the present disclosure, the content text code may be gradually fused with the self-attention processing result, so that target content may be gradually represented in a reverse diffusion processing process.

As an example, refer to Formula (3):

$$\{ \begin{matrix}{Q}_{t} = {W}_{Qt} \cdot y ; {K}_{t} = {W}_{Kt} \cdot {f}_{t} ; {V}_{t} = {W}_{Vt} \cdot {f}_{t} \\ Attention ( {Q}_{t} , {K}_{t} , {V}_{t} ) = softmax ( \frac{{Q}_{t} {K}_{t}^{T}}{\sqrt{d}} ) \cdot {V}_{t}\end{matrix} ; \qquad ( 3 )$$

where W_{Qt} is a first query parameter, y is an output of a self-attention module, W_{Kt} is a first key parameter, W_{Vt} is a first value parameter, fₜ is a style feature, d is a dimension, Qₜ is a first query matrix, Kₜ is a first key matrix, Vₜ is a first value matrix, and Attention (Qₜ, Kₜ, Vₜ) is an output of a text cross-attention module (a text cross-attention processing result).

In some embodiments, the performing cross-attention processing on the self-attention processing result of the (m+1)^{th} sampling network and the style code to obtain a style cross-attention processing result of the (m+1)^{th} sampling network may be implemented by using the following technical solution: performing second query parameter-based mapping processing on the self-attention processing result of the (m+1)^{th} sampling network to obtain a second query matrix; performing second key parameter-based mapping processing on the style code to obtain a second key matrix; performing second value parameter-based mapping processing on the style code to obtain a second value matrix; and performing attention calculation on the second query matrix, the second key matrix, and the second value matrix to obtain the style cross-attention processing result of the (m+1)^{th} sampling network. According to this embodiment of the present disclosure, the style code may be gradually fused with the self-attention processing result, so that a target style may be gradually represented in a reverse diffusion processing process.

As an example, refer to Formula (4):

$$\{ \begin{matrix}{Q}_{s} = {W}_{Qs} \cdot y ; {K}_{s} = {W}_{Ks} \cdot {f}_{s} ; {V}_{s} = {W}_{Vs} \cdot {f}_{s} \\ Attention ( {Q}_{s} , {K}_{s} , {V}_{s} ) = softmax ( \frac{{Q}_{s} {K}_{s}^{T}}{\sqrt{d}} ) \cdot {V}_{s}\end{matrix} ; \qquad ( 4 )$$

where W_{Qs} is a second query parameter, y is an output of the self-attention module, W_{Ks} is a second key parameter, W_{Vs} is a second value parameter, fₛ is a text feature, d is a dimension, Qₛ is a second query matrix, Kₛ is a second key matrix, Vₛ is a second value matrix, and Attention (Qₛ, Kₛ, Vₛ) is an output of a style cross-attention module.

Parameters involved in this embodiment of the present disclosure are all parameters obtained through training, for example, parameters such as the second key parameter and the first key parameter.

Content text is obtained, a style image having a target style is obtained, text encoding processing is performed on the content text to obtain content text code of the content text, and style encoding processing is performed on the style image to obtain style code. The content text code and the style code are fused into a process of performing reverse diffusion processing on a noise image by using a dual cross-attention mechanism, so that a target image matching the content text and the target style can be obtained at a time, thereby improving image generation efficiency.

An exemplary application of the embodiment of the present disclosure in an actual application scene will be described below.

The terminal (on which an image editing client runs) may be configured to obtain an image generation request. For example, a user inputs content text and a style image by using an input interface of the terminal (controls corresponding to different styles are triggered through a selection operation, and after a control of any style is triggered, a plurality of style images corresponding to the styles are obtained) to generate the image generation request. The terminal sends the image generation request to the server. The server performs text encoding processing on the content text to obtain content text code of the content text, and performs style encoding processing on the style image to obtain style code. Based on a dual cross-attention mechanism corresponding to the style code and the content text code, reverse diffusion processing is performed on a noise image to obtain a target image matching content of the content text and having a target style, and the server returns the target image to the terminal.

This embodiment of the present disclosure mainly provides a style adapter configured to generate a style image. Based on a diffusion model implemented by the dual cross-attention mechanism and a semantic style decoupling policy of the style image, the style adapter generates an image with user expected content and a user expected style according to the content text (prompt) and a style reference image (that is, the style image described above).

FIG. 4 is a schematic diagram of architecture of a style adapter according to an embodiment of the present disclosure.

The style adapter includes a text model configured for parsing content text, a vision model configured for parsing the style reference image, a learnable style embedding network (Style Emb), and a diffusion model implemented based on two attention mechanisms.

Specified content text P and a series of style reference imagesR={I₀, I₁, . . . , I_{K-1}} are first respectively parsed into a text feature fₜ and a visual feature {f₀, f₁, . . . , f_{K-1}} by using the text model and the vision model. Then, the style embedding network fuses the visual feature {f₀, f₁, . . . , f_{K-1}} into a style feature fₛ.fₜ and fₛ are respectively input into a two-way cross-attention module in the diffusion model. Specifically, fₜ is input into T-CrossA, where T-CrossA represents a text cross-attention module, and fₛ is input into an S-CrossA, where S-CrossA represents a style cross-attention module, so that the diffusion model can generate an image Iₒ with content consistent with the content text, and a style consistent with a style reference image.

Network structures whose parameters need to be updated in a training stage are the style cross-attention module and the style embedding network, and the remaining network structures are obtained after training is completed in pre-training.

The text model and the vision model involved in this embodiment of the present disclosure may be a CLIP. Through simple image-text bi-encoder contrastive learning and a large quantity of image-text corpora, the models have a significant image-text feature alignment capability, and have a significant effect in zero-sample image classification and cross-modal retrieval.

The diffusion model involved in this embodiment of the present disclosure is formed by cascading a plurality of reverse diffusion (denoising) networks. Each reverse diffusion network includes a plurality of sampling layers (an upsampling layer and a downsampling layer), and each sampling layer includes a self-attention module and a two-way cross-attention module. The two-way cross-attention module includes two parallel cross-attention modules T-CrossA and S-CrossA, and separately process a text feature fₜ and a style feature fₜ. The processing results of the text feature and the style feature are combined through a parameter λ, referring to Formula (5) to Formula (7):

$$\{ \begin{matrix}{Q}_{t} = {W}_{Qt} \cdot y ; {K}_{t} = {W}_{Kt} \cdot {f}_{t} ; {V}_{t} = {W}_{Vt} \cdot {f}_{t} \\ Attention ( {Q}_{t} , {K}_{t} , {V}_{t} ) = softmax ( \frac{{Q}_{t} {K}_{t}^{T}}{\sqrt{d}} ) \cdot {V}_{t}\end{matrix} ; \qquad ( 5 )$$

where W_{Qt} is a first query parameter, y is an output of a self-attention module, W_{Kt} is a first key parameter, W_{Vt} is a first value parameter, fₜ is a style feature, d is a dimension, Qₜ is a first query matrix, Kₜ is a first key matrix, Vₜ is a first value matrix, and Attention (Qₜ, Kₜ, Vₜ) is an output of a text cross-attention module.

$$\{ \begin{matrix}{Q}_{s} = {W}_{Qs} \cdot y ; {K}_{s} = {W}_{Ks} \cdot {f}_{s} ; {V}_{s} = {W}_{Vs} \cdot {f}_{s} \\ Attention ( {Q}_{s} , {K}_{s} , {V}_{s} ) = softmax ( \frac{{Q}_{s} {K}_{s}^{T}}{\sqrt{d}} ) \cdot {V}_{s}\end{matrix} , \qquad ( 6 ) ;$$

where W_{Qs} is a second query parameter, y is an output of the self-attention module, W_{Ks} is a second key parameter, W_{Vs} is a second value parameter, fₛ is a text feature, d is a dimension, Qₛ is a second query matrix, Kₛ is a second key matrix, Vₛ is a second value matrix, and Attention (Qₛ, Kₛ, V_{S}) is an output of a style cross-attention module.

$$\hat{y} = Attention ( {Q}_{t} , {K}_{t} , {V}_{t} ) + λ Attention ( {Q}_{s} , {K}_{s} , {V}_{s} ) . \qquad ( 7 ) ;$$

where ŷ is an output of the two-way crossing attention module, A is a trainable fusion parameter, Attention (Qₛ, Kₛ, Vₛ) is an output of the style cross-attention module, and Attention (Qₜ, Kₜ, Vₜ) is an output of the text cross-attention module.

The style embedding network (StyleEmb) involved in this embodiment of the present disclosure is described below with reference to FIG. 5. The style embedding network is a Transformer structure including a plurality of attention modules. An input of the Transformer structure is formed by stitching a feature fᵣ stitched by a visual feature {f₀, f₁, . . . , f_{K-1}} of a style reference image and a learnable embedding feature fₘ. After using the Transformer structure, \hat{f}ᵣ and \hat{f}ₘ are generated, and \hat{f}ₘ is mapped to fₛ through a learnable matrix M_{S} to participate in a subsequent generation process.

The following describes the semantic style decoupling policy of the style image.

To decouple semantics and styles in the style image, and alleviate interference of the semantics in the style image on generated image content, three effective decoupling policies are provided in various embodiments of the present disclosure.

First, block-based disorganizing is performed on the style reference image. Semantic information of the style reference image is interfered while reserving style details such as texture and brush strokes in a reference image.

Second, class embedding information in a vision model configured for parsing a style image is removed, referring to Formula (8):

$${E}_{Ir} = [ {E}_{c l s} , {I}_{r}^{0} E , {I}_{r}^{1} E , {I}_{r}^{N - 1} E ] + {E}_{p o s} ; \qquad ( 8 )$$

where E_{cls} is a class embedding (associated with a class) obtained by using the vision model, Eₚₒₛ represents location information of each image block, {Iᵣ⁰, Iᵣ¹, . . . Iᵣ^{N-1}} is non-overlapping image blocks obtained by dividing the style image. Formula (8) is a formula for the vision model to process the style reference image, and E_{cls} is closely related to semantic information in the style image, so the semantic information in the style image is discarded by removing E_{cls} in this embodiment of the present disclosure.

Third, a plurality of style reference images having strong semantic diversity are provided, that is, the style reference images are formed by a plurality of images in the same style, and semantics of the images are as different as possible. This approach enables a model to tend to obtain common style features in these reference images when generating an image, and discard uneven semantic features.

According to the style adapter according to this embodiment of the present disclosure, the same model is configured for generating various images having content consistent with the content text and having a style consistent with that of the reference image through the two cross-attention mechanisms and three decoupling policies.

The following describes a test effect of a style adapter according to this embodiment of the present disclosure.

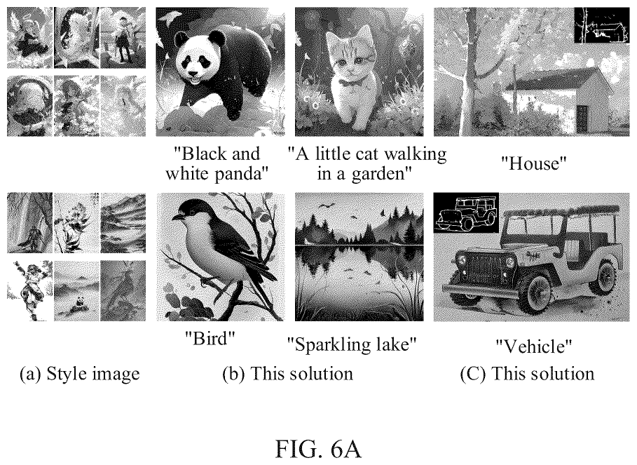

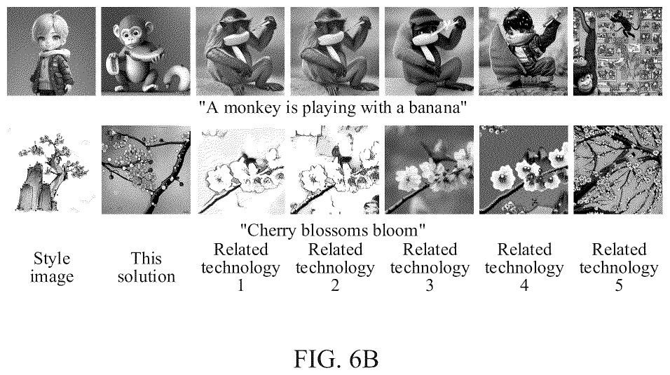

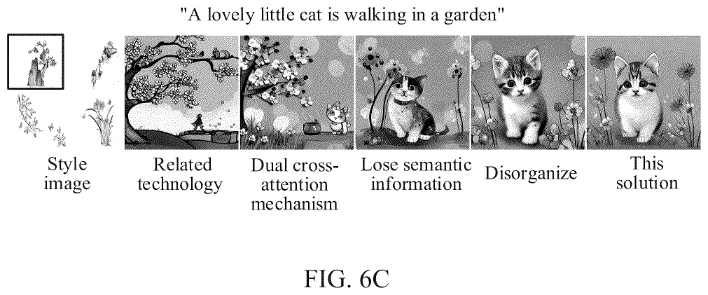

Referring to FIG. 6A, style images in a plurality of styles are given. The style adapter according to this embodiment of the present disclosure can generate a target image meeting a style and content text in one transferring process. In addition, this embodiment of the present disclosure has compatibility with another controllable condition. The another controllable condition herein may be a sketch, as shown in a result in a last column in FIG. 6A. Under guidance of an additional sketch, a shape of generated content is more controllable.

Referring to FIG. 6B and Table 1, Table 1 shows scores of related technologies and this solution at two levels of text similarity and style similarity. Only coarse-grained color transformation is performed in a related technology 1 and a related technology 2. A related technology 3 fails to produce satisfactory stylization because text extracted from a style image has poor performance. A related technology 4 relies on text inversion, and achieves a better result in content-based style transformation than prompt-based style transformation, but there is still a relatively large difference between a style obtained by the related technology 4 and that of a style image. By contrast, the target image generated by the style adapter according to this embodiment of the present disclosure is more faithful to the target style of the style image, especially in aspects such as brush strokes and lines. In this embodiment of the present disclosure, a target image more matching the content text is generated, and content fidelity and style fidelity are better balanced.

TABLE 1
Text similarity and style similarity scoring table of each solution

| | Single style image | | | | | | A plurality of style images | | |
|---|---|---|---|---|---|---|---|---|---|
| | Related | Related | Related | Related | Related | This | Related | Related | This |
| Mode | technology 1 | technology 2 | technology 3 | technology 4 | technology 5 | solution | technology 6 | technology 7 | solution |
| Text | 0.2323 | 0.2340 | 0.2204 | 0.1682 | 0.2145 | 0.24335 | 0.1492 | 0.2390 | 0.2448 |
| similarity | | | | | | | | | |
| Style | 0.8517 | 0.8493 | 0.8616 | 0.8707 | 0.8528 | 0.8645 | 0.9289 | 0.9034 | 0.9031 |
| similarity | | | | | | | | | |

Referring to FIG. 6C, an experiment is performed in this embodiment of the present disclosure to evaluate effectiveness of a dual cross-attention mechanism module and three decoupling policies. A target image not obtained in this solution is obtained by using a single style image, and a target image corresponding to this solution is obtained by using a plurality of style images. In the related technology, a cat cannot be generated based on content text, and the cat can be generated by using a dual cross-attention mechanism. Further, the cat is visible in a mode of losing semantic information. In a mode of disorganizing image blocks, a high-fidelity generation effect is achieved in this embodiment of the present disclosure. According to this embodiment of the present disclosure, content fidelity and style fidelity can be better balanced by introducing a trainable parameter A.

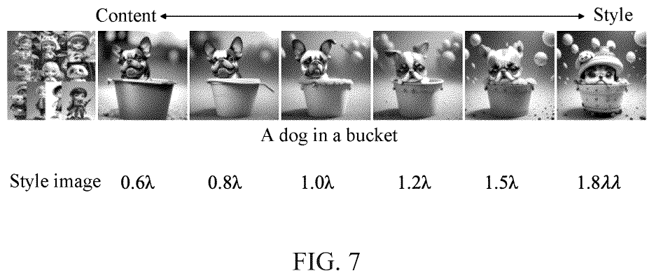

Referring to FIG. 7, the dual cross-attention module according to this embodiment of the present disclosure fuses information of content text and style reference through λ, where λ is an adaptive parameter, and controls a balance between guidance from the content text and guidance from the style image. When λ is zoomed out by a factor less than 1.0, the guidance from the style image gradually disappears, and the generated target image becomes more natural. On the other hand, when λ is zoomed in by a factor greater than 1.0, the style in the generated target image becomes more prominent, but a dog in the image loses a natural appearance of the dog. Therefore, in this embodiment of the present disclosure, the generated target image may be customized by tuning A according to a preference.

In this embodiment of the present disclosure, relevant data such as user information is involved. When this embodiment of the present disclosure is applied to a specific product or technology, user permission or consent needs to be obtained, and collection, use, and processing of the relevant data need to comply with relevant laws, regulations, and standards of relevant countries and regions.

The following continues to describe an exemplary structure that an implementation of an image generation apparatus 455 according to this embodiment of the present disclosure is a software module. In some embodiments, as shown in FIG. 2, the software module stored in the image generation apparatus 455 of a memory 450 may include: an obtaining module 4551, configured to obtain content text, and obtain a style image having a target style; an encoding module 4552, configured to perform text encoding processing on the content text to obtain content text code of the content text, and extract style code from the style image; and a reverse diffusion module 4553, configured to perform reverse diffusion processing on a noise image based on a dual cross-attention mechanism corresponding to the style code and the content text code to obtain a target image, the target image matching content of the content text, and the target image having the target style.

In some embodiments, the obtaining module 4551 is further configured to: obtain at least one original style image having the target style; and perform the following processing on each original style image: performing block segmentation processing on the original style image to obtain a plurality of image blocks of the original style image; and performing disorganizing and stitching processing on the plurality of image blocks of the original style image to obtain the style image having the target style.

In some embodiments, the encoding module 4552 is further configured to: perform the following processing on each style image: performing image encoding processing on the style image to obtain image code of the style image; performing attention mechanism-based encoding processing on the image code of the style image to obtain attention image code of the style image; when a plurality of style images exist, performing stitching processing on the attention image code of the plurality of style images to obtain a first stitching result, and performing first embedding processing on the first stitching result to obtain the style code; and when one style image exists, performing first embedding processing on the attention image code of the style image to obtain the style code.

In some embodiments, the text encoding processing and the image encoding processing are implemented by invoking a CLIP model. The encoding module 4552 is further configured to: obtain a plurality of first text samples and a first image sample matching each first text sample; perform, by using a vision model of the CLIP model, image encoding processing on each first image sample to obtain image code of each first image sample; perform, by using a text model of the CLIP model, text encoding processing on each first text sample to obtain text code of each first text sample; determine a text-image contrastive loss based on the text code of each first text sample, the image code of each first image sample, and a matching relationship between each first text sample and each first image sample; and update a parameter of the CLIP model based on the text-image contrastive loss.

In some embodiments, the encoding module 4552 is further configured to: perform the following processing on each style image: obtaining semantic code representing a semantic type of the style image; obtaining a plurality of image blocks of the style image; performing second embedding processing on each image block to obtain visual code of each image block, and performing third embedding processing on each image block to obtain position code of each image block; performing stitching processing on the semantic code and the visual code of the plurality of image blocks to obtain a second stitching result; and performing superimposition processing corresponding to the image block on the second stitching result and the position code of each image block to obtain the image code of the style image.

In some embodiments, before the performing attention mechanism-based encoding processing on the image code of the style image to obtain attention image code of the style image, the encoding module 4552 is further configured to: perform the following processing on each style image: removing the semantic code representing the semantic type of the style image from the image code of the style image, and updating a removal result to the image code of the style image.

In some embodiments, the reverse diffusion module 4553 is further configured to: perform, by using an n^{th} reverse diffusion network of n cascaded reverse diffusion networks, dual cross-attention mechanism-based reverse diffusion processing on an input of the n^{th} reverse diffusion network, and transmit an n^{th} reverse diffusion result output by the n^{th} reverse diffusion network to an (n+1)^{th} reverse diffusion network to continue performing the dual cross-attention mechanism-based reverse diffusion processing to obtain an (n+1)^{th} reverse diffusion result corresponding to the (n+1)^{th} reverse diffusion network; generate the target image based on an N^{th} reverse diffusion result corresponding to the N^{th} reverse diffusion network, where n is an integer variable whose value progressively increases from 1, a value range of n is 1≤n<N, when a value of n is 1, an input of the n^{th} reverse diffusion network is the noise image, the content text code, and the style code; and when the value of n is 2≤n<N, the input of the n^{th} reverse diffusion network is an (n−1)^{th} reverse diffusion result output by an (n−1)^{th} reverse diffusion network, the content text code, and the style code.

In some embodiments, the n^{th} reverse diffusion network includes cascaded M sampling networks, and a value of M satisfies: 2≤M. The reverse diffusion module 4553 is further configured to: perform, by using an m^{th} sampling network in the M cascaded sampling networks, dual cross-attention mechanism-based sampling processing on an input of the m^{th} sampling network to obtain an m^{th} sampling result corresponding to the m^{th} sampling network, and transmitting the m^{th} sampling result corresponding to the m^{th} sampling network to an (m+1)^{th} sampling network to continue performing the dual cross-attention mechanism-based sampling processing to obtain an (m+1)^{th} sampling result corresponding to the (m+1)^{th} sampling network; use a sampling result output by an M^{th} sampling network as the n^{th} reverse diffusion result, where m is an integer variable whose value progressively increases from 1, a value range of m is 1≤m≤M−1, when a value of m is 1, an input of the m^{th} sampling network is an input of the n^{th} reverse diffusion network; and when a value of m is 2≤m<M, the input of the m^{th} sampling network is an (m−1)^{th} sampling result output by an (m−1)^{th} sampling network, the content text code, and the style code.

In some embodiments, the reverse diffusion module 4553 is further configured to: perform self-attention processing on the m^{th} sampling result corresponding to the m^{th} sampling network to obtain a self-attention processing result of the (m+1)^{th} sampling network; perform cross-attention processing on the self-attention processing result of the (m+1)^{th} sampling network and the content text code to obtain a text cross-attention processing result of the (m+1)^{th} sampling network; perform cross-attention processing on the self-attention processing result of the (m+1)^{th} sampling network and the style code to obtain a style cross-attention processing result of the (m+1)^{th} sampling network; and perform fusion processing on the style cross-attention processing result of the (m+1)^{th} sampling network and the text cross-attention processing result of the (m+1)^{th} sampling network to obtain an (m+1)^{th} sampling result corresponding to the (m+1)^{th} sampling network.

In some embodiments, the reverse diffusion module 4553 is further configured to: perform first query parameter-based mapping processing on the self-attention processing result of the (m+1)^{th} sampling network to obtain a first query matrix; perform first key parameter-based mapping processing on the content text code to obtain a first key matrix; perform first value parameter-based mapping processing on the content text code to obtain a first value matrix; and perform attention calculation on the first query matrix, the first key matrix, and the first value matrix to obtain the text cross-attention processing result of the (m+1)^{th} sampling network.

In some embodiments, the reverse diffusion module 4553 is further configured to: perform second query parameter-based mapping processing on the self-attention processing result of the (m+1)^{th} sampling network to obtain a second query matrix; perform second key parameter-based mapping processing on the style code to obtain a second key matrix; perform second value parameter-based mapping processing on the style code to obtain a second value matrix; and perform attention calculation on the second query matrix, the second key matrix, and the second value matrix to obtain the style cross-attention processing result of the (m+1)^{th} sampling network.

The embodiments of the present disclosure provide a computer program product. The computer program product includes computer-executable instructions. The computer-executable instructions are stored in a computer-readable storage medium. A processor of an electronic device reads the computer-executable instructions from the computer-readable storage medium, and the processor executes the computer-executable instructions to enable the electronic device to perform the image generation method according to the embodiments of the present disclosure.

The embodiments of the present disclosure provide a computer-readable storage medium having computer-executable instructions stored therein. The computer-executable instructions are stored in the computer-readable storage medium. The computer-executable instructions, when executed by a processor, perform the image generation method according to the embodiments of the present disclosure.

In some embodiments, the computer-readable storage medium may be a memory such as an FRAM, a ROM, a PROM, an EPROM, an EEPROM, a flash memory, a magnetic surface memory, an optical disk, or a CD-ROM, or may be various devices including one of or any combination of the above memories.

In some embodiments, the computer-executable instructions may be in the form of a program, software, a software module, a script, or code, programmed in any form of programming language (including compiled or interpreted languages, or declarative or procedural languages), may be deployed in any form, and includes other units that are deployed as a standalone program or as a module, component, subroutine, or are suitable to be used in a computing environment.

As an example, the computer-executable instructions may be, but not necessarily, corresponding to a file in a file system, may be stored in a part of the file for saving other programs or data, for example, stored in one or more scripts in a hyper text markup language (HTML) file, stored in a single file specifically used for the program being discussed, or stored in a plurality of collaborative files (for example, a file storing one or more modules, a submodule, or a code part).

As an example, the computer-executable instructions may be deployed on a computing device for executing, or executed on a plurality of computing devices located at a location, or executed on a plurality of computing devices distributed in a plurality of locations and interconnected through communication networks.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

In conclusion, according to this embodiment of the present disclosure, content text is obtained, a style image having a target style is obtained, text encoding processing is performed on the content text to obtain content text code of the content text, and style encoding processing is performed on the style image to obtain style code. The content text code and the style code are fused into a process of performing reverse diffusion processing on a noise image by using a dual cross-attention mechanism, so that a target image matching the content text and the target style can be obtained at a time, thereby improving image generation efficiency.

The foregoing descriptions are only an example of the present disclosure and are not intended to limit the scope of protection of the present disclosure. Any modification, equivalent replacement, or improvement made without departing from the spirit and principle of the present disclosure shall fall within the protection scope of the present disclosure.

What is claimed is:

1. A method for generating image based on artificial intelligence (AI), performed by an electronic device comprising a memory storing instructions and a processor in communication with the memory, and comprising:
obtaining content text;
obtaining at least one style image having a target style;
performing text encoding processing on the content text to obtain content text code of the content text;
extracting style code from the at least one style image; and
performing reverse diffusion processing on a noise image based on a dual cross-attention mechanism corresponding to the style code and the content text code to obtain a target image, wherein the target image corresponds to the content text and has the target style.

2. The method according to claim 1, wherein the obtaining the at least one style image having the target style comprises:
obtaining at least one original style image having the target style; and
performing the following processing on each original style image:
performing block segmentation processing on the original style image to obtain a plurality of image blocks of the original style image; and
performing disorganizing and stitching processing on the plurality of image blocks of the original style image to obtain the at least one style image having the target style.

3. The method according to claim 1, wherein the extracting the style code from the at least one style image comprises:
performing the following processing on each style image:
performing image encoding processing on the style image to obtain image code of the style image, and
performing attention mechanism-based encoding processing on the image code of the style image to obtain attention image code of the style image;
in response to the at least one style images comprising a plurality of style images, performing stitching processing on the attention image code of the plurality of style images to obtain a first stitching result, and performing first embedding processing on the first stitching result to obtain the style code; and
in response to the at least one style images comprising only one style image, performing first embedding processing on the attention image code of the style image to obtain the style code.

4. The method according to claim 3, wherein:
the text encoding processing and the image encoding processing are performed with a contrastive language-image pre-training (CLIP) process comprising a vision part and a text part.

5. The method according to claim 4, further comprising:
obtaining a plurality of first text samples and a first image sample matching each first text sample;
performing, by using the vision part, image encoding processing on each first image sample to obtain image code of each first image sample;
performing, by using the text part, text encoding processing on each first text sample to obtain text code of each first text sample;
determining a text-image contrastive loss based on the text code of each first text sample, the image code of each first image sample, and a matching relationship between each first text sample and each first image sample; and
updating a parameter of the CLIP process based on the text-image contrastive loss.

6. The method according to claim 3, wherein the performing image encoding processing on the style image to obtain the image code of the style image comprises:
obtaining a semantic code representing a semantic type of the style image;
obtaining a plurality of image blocks of the style image;
performing second embedding processing on each image block to obtain visual code of each image block, and performing third embedding processing on each image block to obtain position code of each image block;
performing stitching processing on the semantic code and the visual code of the plurality of image blocks to obtain a second stitching result; and
performing superimposition processing corresponding to the image block on the second stitching result and the position code of each image block to obtain the image code of the style image.

7. The method according to claim 6, wherein before the performing attention mechanism-based encoding processing on the image code of the style image to obtain the attention image code of the style image, the method further comprises:
removing the semantic code representing the semantic type of the style image from the image code of the style image, and updating a removal result to the image code of the style image.

8. The method according to claim 1, wherein the performing reverse diffusion processing on the noise image based on the dual cross-attention mechanism corresponding to the style code and the content text code to obtain the target image comprises:
performing, by using an n^{th} reverse diffusion network of N cascaded reverse diffusion networks, dual cross-attention mechanism-based reverse diffusion processing on an input of the n^{th} reverse diffusion network, and transmitting an n^{th} reverse diffusion result output by the n^{th} reverse diffusion network to an (n+1)^{th} reverse diffusion network to continue performing the dual cross-attention mechanism-based reverse diffusion processing to obtain an (n+1)^{th} reverse diffusion result corresponding to the (n+1)^{th} reverse diffusion network; and
generating the target image based on an N^{th} reverse diffusion result corresponding to the N^{th} reverse diffusion network,
wherein:
n is an integer variable whose value progressively increases from 1, a value range of n is 1≤n<N,
when a value of n is 1, an input of the n^{th} reverse diffusion network is the noise image, the content text code, and the style code, and
when the value of n is 2≤n<N, the input of the n^{th} reverse diffusion network is an (n−1)^{th} reverse diffusion result output by an (n−1)^{th} reverse diffusion network, the content text code, and the style code.

9. The method according to claim 8, wherein:
the n^{th} reverse diffusion network comprises M cascaded sampling networks, and a value of M satisfies: 2≤M; and
the performing, by using the n^{th} reverse diffusion network, dual cross-attention mechanism-based reverse diffusion processing on the input of the n^{th} reverse diffusion network comprises:
performing, by using an m^{th} sampling network in the M cascaded sampling networks, dual cross-attention mechanism-based sampling processing on an input of the m^{th} sampling network to obtain an m^{th} sampling result corresponding to the m^{th} sampling network, and transmitting the m^{th} sampling result corresponding to the m^{th} sampling network to an (m+1)^{th} sampling network to continue performing the dual cross-attention mechanism-based sampling processing to obtain an (m+1)^{th} sampling result corresponding to the (m+1)^{th} sampling network; and
using a sampling result output by an M^{th} sampling network as the n^{th} reverse diffusion result,
wherein:
m is an integer variable whose value progressively increases from 1, a value range of m is 1≤m M−1,
when a value of m is 1, an input of the m^{th} sampling network is an input of the n^{th} reverse diffusion network, the content text code, and the style code, and
when a value of m is 2≤m<M, the input of the m^{th} sampling network is an (m−1)^{th} sampling result output by an (m−1)^{th} sampling network, the content text code, and the style code.

10. The method according to claim 9, wherein the transmitting the m^{th} sampling result corresponding to the m^{th} sampling network to the (m+1)^{th} sampling network to continue performing the dual cross-attention mechanism-based sampling processing to obtain the (m+1)^{th} sampling result corresponding to the (m+1)^{th} sampling network comprises:
performing self-attention processing on the m^{th} sampling result corresponding to the m^{th} sampling network to obtain a self-attention processing result of the (m+1)^{th} sampling network;
performing cross-attention processing on the self-attention processing result of the (m+1)^{th} sampling network and the content text code to obtain a text cross-attention processing result of the (m+1)^{th} sampling network;
performing cross-attention processing on the self-attention processing result of the (m+1)^{th} sampling network and the style code to obtain a style cross-attention processing result of the (m+1)^{th} sampling network; and
performing fusion processing on the style cross-attention processing result of the (m+1)^{th} sampling network and the text cross-attention processing result of the (m+1)^{th} sampling network to obtain an (m+1)^{th} sampling result corresponding to the (m+1)^{th} sampling network.

11. The method according to claim 10, wherein the performing cross-attention processing on the self-attention processing result of the (m+1)^{th} sampling network and the content text code to obtain the text cross-attention processing result of the (m+1)^{th} sampling network comprises:
performing first query parameter-based mapping processing on the self-attention processing result of the (m+1)^{th} sampling network to obtain a first query matrix;
performing first key parameter-based mapping processing on the content text code to obtain a first key matrix;
performing first value parameter-based mapping processing on the content text code to obtain a first value matrix; and
performing attention calculation on the first query matrix, the first key matrix, and the first value matrix to obtain the text cross-attention processing result of the (m+1)^{th} sampling network.

12. The method according to claim 10, wherein the performing cross-attention processing on the self-attention processing result of the (m+1)^{th} sampling network and the style code to obtain the style cross-attention processing result of the (m+1)^{th} sampling network comprises:
performing second query parameter-based mapping processing on the self-attention processing result of the (m+1)^{th} sampling network to obtain a second query matrix;
performing second key parameter-based mapping processing on the style code to obtain a second key matrix;
performing second value parameter-based mapping processing on the style code to obtain a second value matrix; and
performing attention calculation on the second query matrix, the second key matrix, and the second value matrix to obtain the style cross-attention processing result of the (m+1)^{th} sampling network.

13. An apparatus for generating image based on artificial intelligence (AI), the apparatus comprising:
a memory storing instructions; and
a processor in communication with the memory, wherein, when the processor executes the instructions, the processor is configured to cause the apparatus to perform:
obtaining content text;
obtaining at least one style image having a target style;
performing text encoding processing on the content text to obtain content text code of the content text;
extracting style code from the at least one style image; and
performing reverse diffusion processing on a noise image based on a dual cross-attention mechanism corresponding to the style code and the content text code to obtain a target image, wherein the target image corresponds to the content text and has the target style.

14. The apparatus according to claim 13, wherein, when the processor is configured to cause the apparatus to perform obtaining the at least one style image having the target style, the processor is configured to cause the apparatus to perform:
obtaining at least one original style image having the target style; and
performing the following processing on each original style image:
performing block segmentation processing on the original style image to obtain a plurality of image blocks of the original style image; and
performing disorganizing and stitching processing on the plurality of image blocks of the original style image to obtain the at least one style image having the target style.

15. The apparatus according to claim 13, wherein, when the processor is configured to cause the apparatus to perform extracting the style code from the at least one style image, the processor is configured to cause the apparatus to perform:
performing the following processing on each style image:
performing image encoding processing on the style image to obtain image code of the style image, and
performing attention mechanism-based encoding processing on the image code of the style image to obtain attention image code of the style image;
in response to the at least one style images comprising a plurality of style images, performing stitching processing on the attention image code of the plurality of style images to obtain a first stitching result, and performing first embedding processing on the first stitching result to obtain the style code; and
in response to the at least one style images comprising only one style image, performing first embedding processing on the attention image code of the style image to obtain the style code.

16. The apparatus according to claim 15, wherein:
the text encoding processing and the image encoding processing are performed with a contrastive language-image pre-training (CLIP) process comprising a vision part and a text part.

17. The apparatus according to claim 13, wherein, when the processor is configured to cause the apparatus to perform reverse diffusion processing on the noise image based on the dual cross-attention mechanism corresponding to the style code and the content text code to obtain the target image, the processor is configured to cause the apparatus to perform:
performing, by using an n^{th} reverse diffusion network of N cascaded reverse diffusion networks, dual cross-attention mechanism-based reverse diffusion processing on an input of the n^{th} reverse diffusion network, and transmitting an n^{th} reverse diffusion result output by the n^{th} reverse diffusion network to an (n+1)^{th} reverse diffusion network to continue performing the dual cross-attention mechanism-based reverse diffusion processing to obtain an (n+1)^{th} reverse diffusion result corresponding to the (n+1)^{th} reverse diffusion network; and
generating the target image based on an N^{th} reverse diffusion result corresponding to the N^{th} reverse diffusion network,
wherein:
n is an integer variable whose value progressively increases from 1, a value range of n is 1≤n<N,
when a value of n is 1, an input of the n^{th} reverse diffusion network is the noise image, the content text code, and the style code, and
when the value of n is 2≤n<N, the input of the n^{th} reverse diffusion network is an (n−1)^{th} reverse diffusion result output by an (n−1)^{th} reverse diffusion network, the content text code, and the style code.

18. A non-transitory computer-readable storage medium, storing computer-readable instructions, wherein, the computer-readable instructions, when executed by a processor, are configured to cause the processor to perform:
obtaining content text;
obtaining at least one style image having a target style;
performing text encoding processing on the content text to obtain content text code of the content text;
extracting style code from the at least one style image; and
performing reverse diffusion processing on a noise image based on a dual cross-attention mechanism corresponding to the style code and the content text code to obtain a target image, wherein the target image corresponds to the content text and has the target style.

19. The non-transitory computer-readable storage medium according to claim 18, wherein, when the computer-readable instructions are configured to cause the processor to perform obtaining the at least one style image having the target style, the computer-readable instructions are configured to cause the processor to perform:
obtaining at least one original style image having the target style; and
performing the following processing on each original style image:
performing block segmentation processing on the original style image to obtain a plurality of image blocks of the original style image; and
performing disorganizing and stitching processing on the plurality of image blocks of the original style image to obtain the at least one style image having the target style.

20. The non-transitory computer-readable storage medium according to claim 18, wherein, when the computer-readable instructions are configured to cause the processor to perform extracting the style code from the at least one style image, the computer-readable instructions are configured to cause the processor to perform:
performing the following processing on each style image:
performing image encoding processing on the style image to obtain image code of the style image, and
performing attention mechanism-based encoding processing on the image code of the style image to obtain attention image code of the style image;
in response to the at least one style images comprising a plurality of style images, performing stitching processing on the attention image code of the plurality of style images to obtain a first stitching result, and performing first embedding processing on the first stitching result to obtain the style code; and
in response to the at least one style images comprising only one style image, performing first embedding processing on the attention image code of the style image to obtain the style code.
